(19) United States
(12) Patent Application Publication
(10) Pub. No.: US 2015/0069767 A1
(43) Pub. Date: Mar. 12, 2015

(54) DOOR OUTSIDE HANDLE ASSEMBLY FOR VEHICLE

(71) Applicant: Hyundai Motor Company, Seoul (KR)

(72) Inventor: Jin Woo NAM, Seoul (KR)

(73) Assignee: Hyundai Motor Company, Seoul (KR)

(21) Appl. No.: 14/104,523

(22) Filed: Dec. 12, 2013

(30) Foreign Application Priority Data
Sep. 9, 2013 (KR) 10-2013-0107690

(51) Int. Cl. E05B 85/10

(52) U.S. Cl. CPC E05B 85/10
USPC 292/336.3

(57) ABSTRACT

A door outside handle assembly can prevent unlocking of a door latch by a reverse inertial force by allowing a lever not to rotate even though the reverse inertial force is generated at a balance weight after a normal inertial force is generated upon a side collision. The handle assembly may include: a base; an opening handle; a rotating lever connected to a cable for actuating a door latch and rotated by manipulation of the handle to pull the cable in an unlocking direction of the door latch; and a balance weight on the base movable in inside and outside directions, wherein a pushing end part is integrally formed on the lever to prevent rotation of the lever by being pushed by the balance weight when a normal inertial force of the balance weight acting in the outside direction of the vehicle is generated.

### CROSS-REFERENCE TO RELATED APPLICATION

The present application claims priority of Korean Patent Application Number 10-2013-0107690 filed Sep. 9, 2013, the entire contents of which application is incorporated herein for all purposes by this reference.

### BACKGROUND OF INVENTION

1. Field of Invention

The present invention relates to a door outside handle assembly for a vehicle. More particularly, it relates to a door outside handle assembly for a vehicle, which can prevent unlocking of a door latch by a reverse inertial force by allowing a lever not to rotate even though the reverse inertial force is generated at a balance weight after a normal inertial force is generated upon side crash of a vehicle.

2. Description of Related Art

Generally, door outside handle assemblies for vehicles include a handle installed on the outer side surface of a door panel. As shown in FIGS. 1 to 4, a base 10 is installed at an inner side of a door panel 1, and a handle 20 is mounted on the base 10 outside the door panel 1.

Also, a lever 30 may be rotatably mounted on a pin axis 31 installed at the base 10. The lever 30 is configured to rotate about the pin axis 31 when the handle (door outside handle) 10 is pulled.

Also, a connection part 32 of the lever 30 is connected to a latch of a door locking device by a cable (or rod) 40, and a protrusion part 33 is provided at the lower end of the lever 30. The protrusion part 33 is configured to longitudinally extend so as to be stopped in the pulling direction of the handle 20 by a stopper 21 of the handle 20.

The stopper 21 is a part that is integrally formed with the handle 20 installed on the outer side surface of the door panel 1. Since the stopper 21 has a structure to be inserted into the inside of a vehicle from the handle 20 based on the door panel 1 and the base 10, the stopper 21 rotates the lever 30 via the protrusion part 33 while moving in the pulling direction of the handle 20 upon pulling of the handle 20.

Also, a balance weight 34 with a certain volume and weight is integrally formed at the upper end of the lever 30, and a return spring 35 is installed at the pin axis 31, allowing one end portion and the other end portion thereof to be fixed on the base 10 and the lever 30, respectively.

In this configuration, when the handle 20 is pulled, the stopper 21 moves and thus the lever 30 rotates. Thus, a cable 40 connected to the lever 30 is pulled to unlock the door latch.

In FIG. 4, the lever location ‘before operation’ represents a state before the handle is operated at ordinary times, and the lever location ‘after operation’ represents a state when the handle is pulled to open the door. Regarding the handle and the stopper, only the state before the operation is shown in the drawing.

Meanwhile, the balance weight 34 prevents the handle from being pulled due to the inertial load of the handle 20 and parts related thereto upon side crash of a vehicle, allowing the door latch not to be unlocked.

The vehicle door must not open even upon side crash to prevent passengers from being thrown out of a vehicle.

However, upon side crash, a vehicle is primarily subject to a normal inertial force. Regarding the handle 20, since the normal inertial force acts in the same direction as the pulling direction, if the balance weight 34 is absent, a result similar to a case where the handle is actually pulled may occur.

That is, the door panel 1 moves toward the inside direction of a vehicle due to the side crash, but the handle 20 does not move due to the inertia. In this case, due to the inertial force (normal inertial force) toward the outside direction of a vehicle, the handle 20 is influenced by the same action as pulling. Finally, the door latch may be unlocked while the cable 40 is pulled at the same time as the rotation of the lever 30.

In order to prevent this phenomenon, the balance weight 34 is provided, and upon side crash, an inertial force of the same direction as the normal inertial force applied to the handle 20 also acts on the balance weight 34.

Since the normal inertial force of the balance weight 34 acts on the lever 30 with a force of the opposite direction to the rotation direction (counterclockwise in FIG. 4) of the lever 30 when the handle 20 is pulled, the normal inertial force of the balance weight 34 serves to offset the normal inertial force of the handle 20 and thus prevents the oration of the lever 30 and the pulling of the handle 20 such that the door is not opened.

However, regarding the normal inertial force primarily generated at the moment of side crash of a vehicle, the balance weight 34 offsets the inertia of the handle 20 to prevent the rotation of the lever 30, but a reverse inertial force of the opposite direction to the normal inertial force is instantaneously generated by an internal reaction force of a vehicle directly after the side crash, allowing the handle 20 and the balance weight to be influenced by a force toward the inside of a vehicle. Accordingly, the lever 30 may rotate, and thus the door latch may be unlocked.

That is, the balance weight 34 is secondarily subject to the reverse inertial force after the generation of the initial normal inertial force, and thus the lever 30 rotates counterclockwise (the same direction as the rotation direction upon pulling of handle) in FIG. 4, unlocking the door latch.

The information disclosed in this Background section is only for enhancement of understanding of the general background of the invention and should not be taken as an acknowledgement or any form of suggestion that this information forms the prior art already known to a person skilled in the art.

### BRIEF SUMMARY

The present invention provides a door outside handle assembly for a vehicle, which can prevent unlocking of a door latch by a reverse inertial force by allowing a lever not to rotate even though the reverse inertial force is generated at a balance weight after a normal inertial force is generated upon side crash of a vehicle.

In one aspect, the present invention provides a door outside handle assembly for a vehicle, including: a base disposed on a door panel; a handle disposed on the base to be manipulated to open a door; a lever rotatably disposed on the base, connected to a cable for actuating a door latch, and rotated by the manipulation of the handle to pull the cable in an unlocking direction of the door latch; and a balance weight disposed on the base so as to be movable in inside and outside direction of the vehicle, wherein a pushing end part is integrally formed on the lever to prevent a rotation of the lever by being pushed by the balance weight when a normal inertial force of the balance weight acting in the outside direction of the vehicle is generated.

The door outside handle assembly may include a guide slot formed in the base to guide the movement of the balance weight, and the balance weight may be movably coupled to the guide slot.

The balance weight may include pins protrusively disposed at both end portions thereof, and the pins may be inserted into the guide slots disposed in parallel in the base.

The door outside handle assembly may further include a weight return spring that is disposed between the balance weight and the base to provide an elastic restoring force for returning the balance weight in a state deformed by the balance weight moving in the inside direction of the vehicle.

The weight return spring may be two parallel coil springs having one end portion thereof coupled to the pin disposed at each end portion of the balance weight and the other end portion thereof coupled to the base.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are perspective views illustrating a typical door outside handle assembly;

FIG. 3 is a front view illustrating a typical door outside handle assembly;

FIG. 4 is a cross-sectional view taken along line A-A of FIG. 3;

FIG. 5 is a perspective view illustrating an exemplary door outside handle assembly according to the present invention;

FIG. 6 is a front view illustrating an exemplary door outside handle assembly according to the present invention;

FIG. 7(A) and FIG. 7(B) are a cross-sectional views taken along line B-B of FIG. 6, which shows the operation states (operation states according to ordinary handling manipulation) of a door outside handle assembly according to the present invention;

FIG. 8(A) and FIG. 8(B) are perspective views illustrating an operation state of an exemplary balance weight upon side crash according to the present invention; and

FIG. 9(A) and FIG. 9(B) are a cross-sectional views taken along line B-B of FIG. 6, which shows the operation states of a balance weight upon side crash.

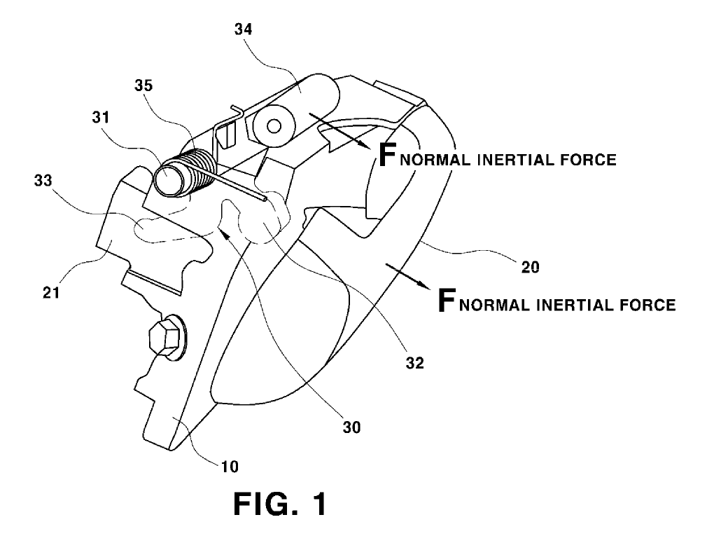

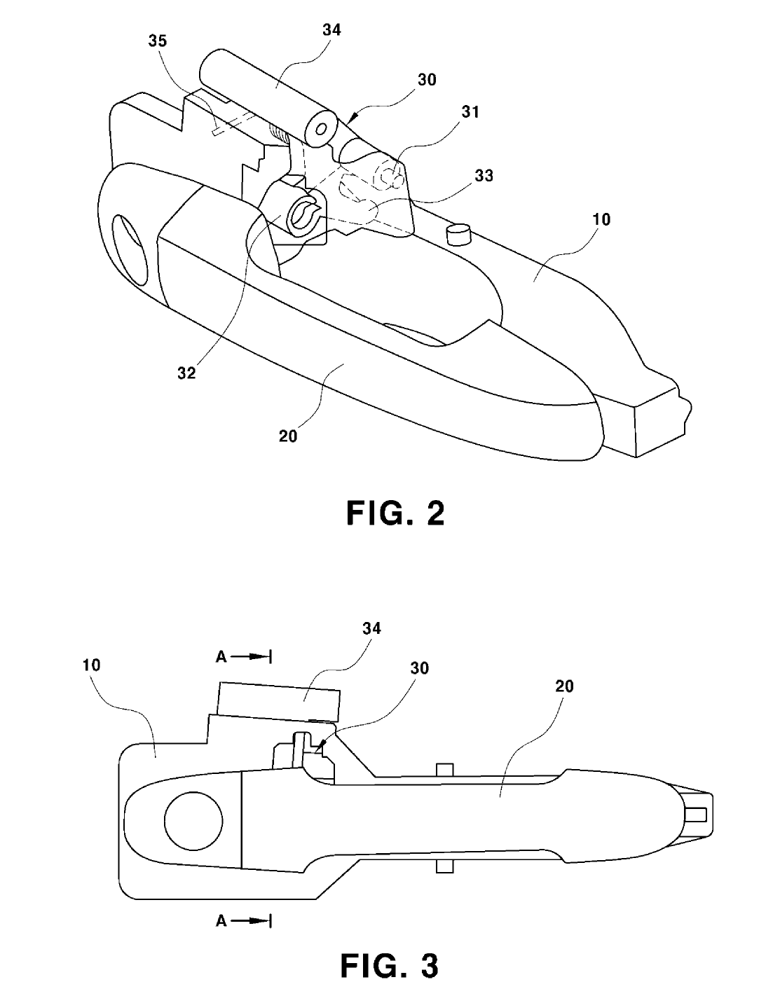

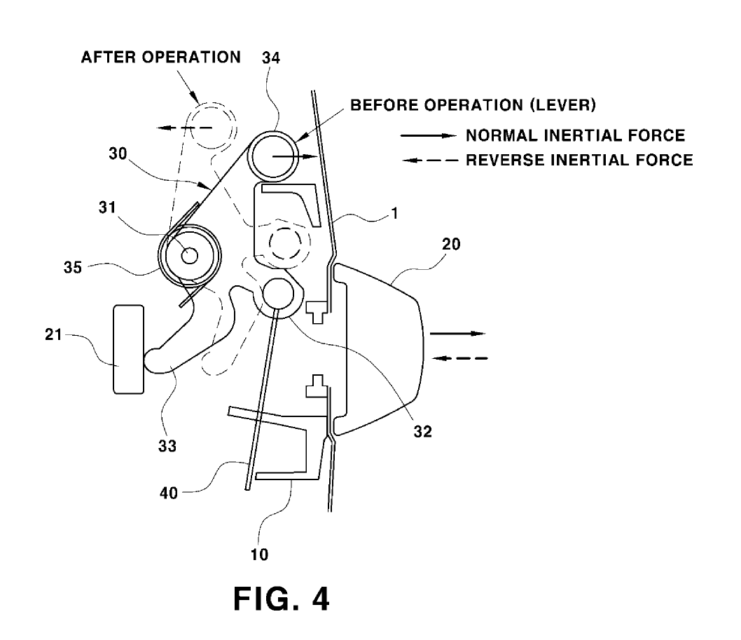

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

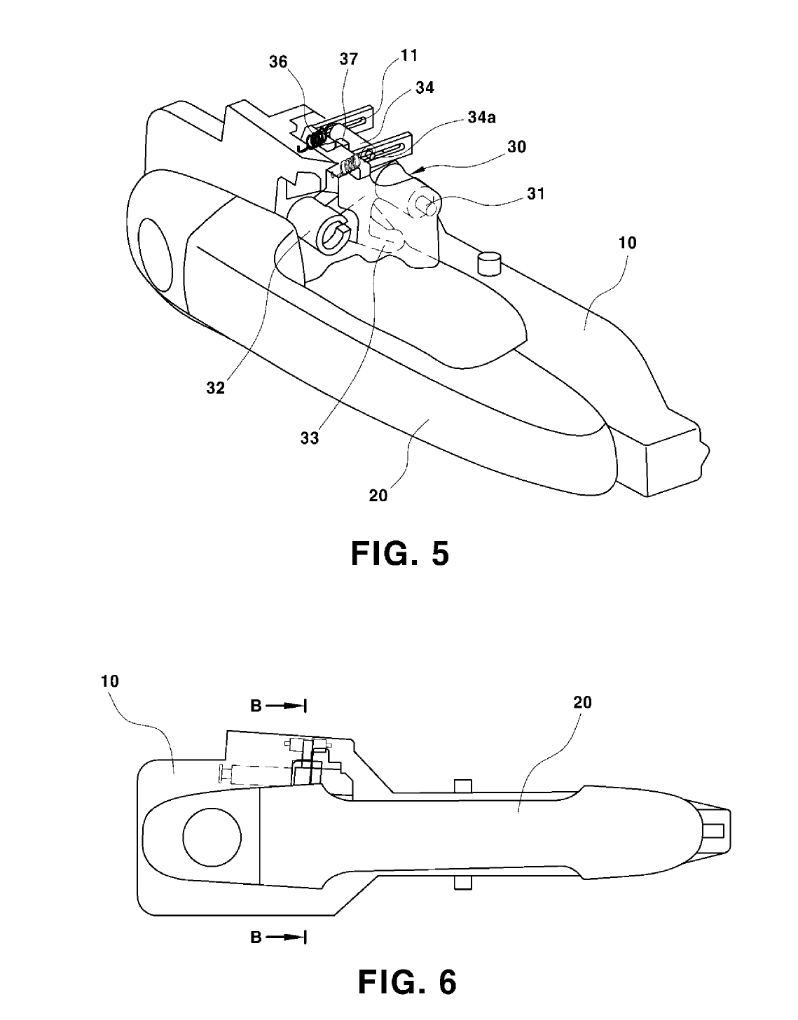

FIG. 5 is a perspective view illustrating a door outside handle assembly according to various embodiments of the present invention, and FIG. 6 is a front view illustrating a door outside handle assembly according to various embodiments of the present invention.

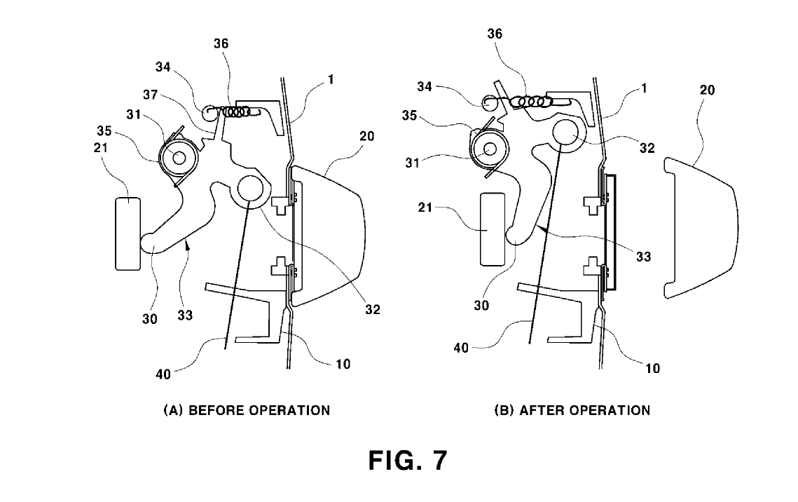

Also, FIG. 7 is a cross-sectional view taken along line B-B of FIG. 6, which shows the operation states (operation states according to ordinary handling manipulation) of a door outside handle assembly according to various embodiments of the present invention. FIG. 7A shows an operation state before the handle is pulled, and FIG. 7B shows an operation state after the handle is pulled to open the door.

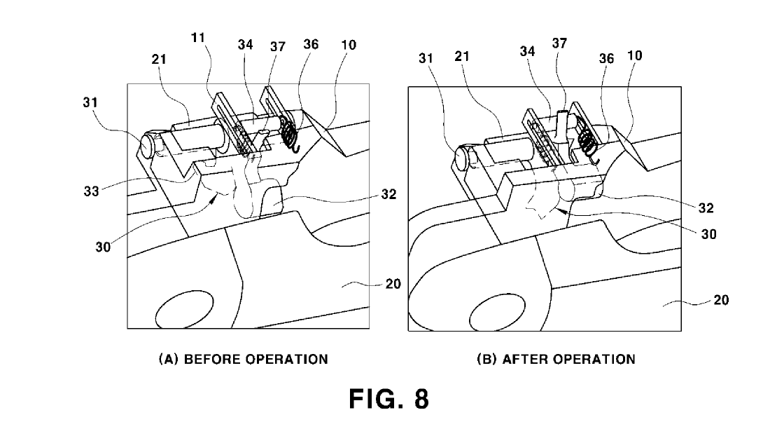

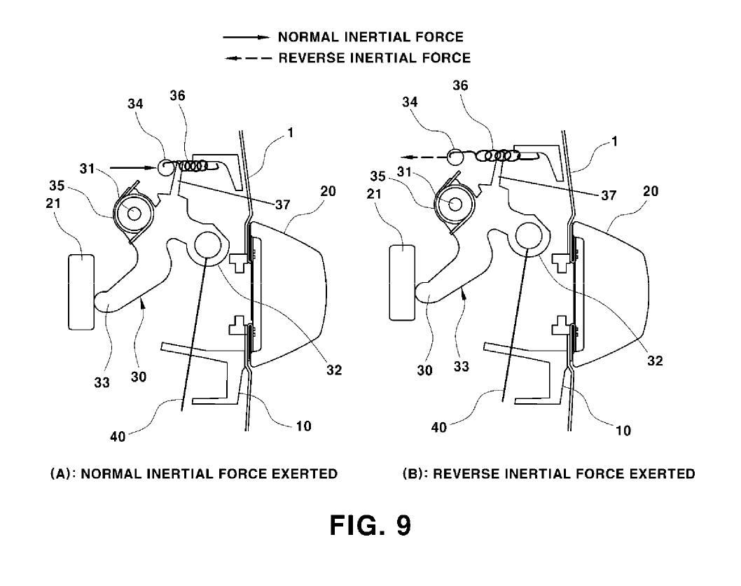

Also, FIG. 8 is a perspective view illustrating an operation state of a balance weight upon side crash according to various embodiments of the present invention, and FIG. 9 is a cross-sectional view taken along line B-B of FIG. 6, which shows the operation states of a balance weight upon side crash. FIG. 9A shows an action of a normal inertial force upon side crash of a vehicle, and FIG. 9B shows an action of a reverse inertial force.

An outside handle assembly according to various embodiments of the present invention may include a base 10 disposed on a door panel 1, a handle 20 mounted on the base 10 to be manipulated for the opening of the door, and a lever 30 rotatably mounted on the base 10, connected to a cable (or rod) 40 for operating a door latch, and rotated by the operation of the handle 20 to actuate the cable 40.

This configuration is a basic configuration of the outside handle assembly in which the lever unlocks the door latch by actuating the cable 40 when the handle 20 rotates the lever 30 such that the door latch can be unlocked in linkage with the manipulation and operation of the handle.

In the accompanying drawings, the cable 40 is illustrated as being used as an actuating factor for the connection with the door latch. However, since a common outside handle assembly for a vehicle uses a rod in addition to a cable for the connection with the door latch, a rod may also be used instead of a cable in various embodiments.

The lever 30 may be rotatably coupled to a pin axis 31 installed at the base 10. The cable 40 may be connected to a connection part 32 formed at one side of the lower portion of the lever 30, and a protrusion part 33 that longitudinally extends may be provided on the other side of the lower portion of the lever 30 so as to be stopped in the pulling direction of the handle 20 by a stopper 21 of the handle 20.

A return spring 35 may be installed at the pin axis 31, and the return spring 35 may have one end portion fixed to the base 10 and the other end portion fixed to the lever 30.

The stopper 21 may be a part that is integrally formed with the handle 20 installed on the outer side surface of the door panel 1. One will appreciate that such integral components may be monolithically formed. Since the stopper 21 has a structure of being inserted into the inside of a vehicle from the handle 20 based on the door panel 1 and the base 10, the stopper 21 may rotate the lever 30 via the protrusion part 33 while moving in the pulling direction of the handle 20 upon pulling of the handle 20.

In this configuration, when the handle 20 is pulled, the stopper 21 may move and thus the lever 30 may rotate. Thus, a cable 40 connected to the lever 30 may be pulled to unlock the door latch.

Unlike a typical configuration in which a balance weight is integrally formed at the upper end of the lever, in various embodiments, a balance weight 34 may be manufactured and assembled independently of the lever 30.

The balance weight 34 may be assembled on the base 10 so as to be movable in inside and outside directions of a vehicle. For this, a guide slot 11 may be longitudinally disposed to guide the movement of the balance weight 34 along the movement direction (inside and outside direction of a vehicle) of the balance weight 34, and the balance weight 34 may be coupled so as to be movable along the guide slot 11.

Here, the inside direction of a vehicle to which the balance weight 34 moves means a direction to which the balance weight 34 is moved by a reverse inertia upon side crash of a vehicle, and the outside direction of a vehicle means a direction to which the balance weight 34 is moved by a normal inertia upon side crash of a vehicle.

In various embodiments, both end portions of the balance weight 34 may be coupled to the guide slot 11 by a pin coupling method to be installed at the base 10 for implementation of the assembling structure of the balance weight 34 movable in the inside and outside directions of a vehicle.

That is, pins 34a that can be inserted into the guide slot 11 may be protrusively disposed at both end portions of the balance weight 34, and two guide slots 11 may be disposed in parallel on the base 10 to allow the pins 34a disposed at each end portion of the balance weight 34 to be inserted into the corresponding guide slots 11.

Also, a weight return spring 36 may be mounted between the balance weight 34 and the base 10 to return the balance weight 34 moved to the inside direction of a vehicle by the reverse inertial force to the outside direction of a vehicle.

The weight return spring 36 may be disposed along the inside and outside directions of a vehicle between the balance weight 34 and the base 10. Accordingly, the weight return spring 36 may be extended when the balance weight 34 is moved in the inside direction of a vehicle by the action of the reverse inertial force (backward inertial force), and then may move the balance weight 34 in the outside direction of a vehicle by an elastic restoring force thereof when the action of the reverse inertial force is released.

In various embodiments, the weight return spring 36 may become two parallel coil springs that have one end portion coupled to the pin 34a formed at each end portion of the balance weight 34 and the other end portion coupled to the base 10.

Also, a pushing end part 37 may be integrally formed at the upper end of the lever 30 such that the balance weight 34 can push the pushing end part 37 in the outside direction of a vehicle. One will appreciate that such integral components may be monolithically formed.

The pushing end part 37 may upwardly extend from the upper end of the lever 30 so as to be located at the rear side (outside direction of a vehicle) of the balance weight 34. Upon side crash, when the balance weight 34 receives a force (forward inertial force, i.e., normal inertial force) of the outside direction of a vehicle, the balance weight 34 may pressurize the pushing end part 37 of the lever 30 such that the lever 30 does not rotate in an unlocking direction (i.e., pulling direction of cable) of the latch even though a normal inertial force occurs in the handle.

In this configuration, a spring force of the weight return spring 36 that is installed to hold the balance weight 34 from the base 10 may act as a force that pulls the balance weight 34 in the outside direction of a vehicle so as to adhere closely to the pushing end part 37 at ordinary times.

Thus, the configuration of the outside handle assembly according to various embodiments of the present invention has been described. Hereinafter, the operation state of the outside handle assembly will be described with reference to FIGS. 7 and 9.

First, FIG. 7A shows a state before operation at the locking state of the door latch, i.e., a state before the handle 20 is pulled, a state before the lever 30 rotates, and a state before the cable 40 is pulled.

In this state, when the handle 20 is pulled to open the door, the state becomes a state after operation (b).

When the handle 20 is pulled, the stopper 21 may move in the outside direction (right direction in the drawing) of a vehicle, which is the pulling direction. In this case, the stopper 21 may push the protrusion part 33 of the lever 30 to rotate the lever 30 counterclockwise. When the lever 30 rotates, the cable 40 is pulled, unlocking the door latch.

In this process, the pushing end part 37 of the lever 30 that rotates may push and move the balance weight 34 in the inside direction of a vehicle, and the weight return spring 36 may be pulled and extended by the balance weight 34 that moves.

Also, the balance weight 34 may move along the guide slot 11 of the base 10, and the pin 34a of the balance weight 34 may be configured to move along the guide slot 11.

Meanwhile, FIG. 9A is a view illustrating a forward inertia primarily acting upon side crash. When a side crash of vehicles occurs in a locking state of the door latch, a normal inertial force may act on both of the handle 20 and the balance weight 34. Accordingly, the inertial force of the balance weight 34 may offset the inertial force of the handle 20, preventing the lever 30 from rotating.

In this case, since the balance weight 34 is pushing the pushing end part 37 of the lever 30 by the inertial force, the lever 30 may not rotate in the pulling direction (unlocking direction) of the cable 40. Accordingly, since the cable 40 is not pulled, the latch may not be unlocked.

On the other hand, when a backward inertial secondarily acts, as shown in FIG. 9B, only the balance weight 34 that is a separate object may move in the inside direction of a vehicle that is the reverse inertia acting direction while extending the weight return spring 36. In this case, since the lever 30 is not influenced by the reverse inertia regardless of the balance weight 34, the lever 30 may not rotate.

Also, since the lever 30 does not rotate, the cable 40 may not be pulled. Accordingly, the locking state of the door latch may not be released.

Also, the balance weight 34 may move along the guide slot 11 of the base 10. Thereafter, when the action of the reverse inertial force disappears, the balance weight 34 may be pulled and returned to the location of FIG. 9A by the elastic restoring force of the weight return spring 36.

According to various embodiments of the present invention, a door outside handle assembly has an effect of preventing a rotation of a lever due to a generation of a reverse inertial force of a balance weight and thus preventing unlocking of a door latch and a door opening upon side crash of a vehicle, by disposing the balance weight that offsets a normal inertial force of a handle generated upon side crash of a vehicle independently of the lever to allow the balance weight to independently move regardless of the lever upon action of the reverse inertial force.

For convenience in explanation and accurate definition in the appended claims, the terms upper or lower, rear, and etc., are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door outside handle assembly for a vehicle, comprising:
a base disposed on a door panel;
a handle disposed on the base that is manipulated to open a door;
a lever rotatably disposed on the base, connected to a cable for actuating a door latch, and rotated by the manipulation of the handle to pull the cable in an unlocking direction of the door latch; and
a balance weight disposed on the base movable in inside and outside directions of the vehicle;
wherein a pushing end part is integrally formed on the lever to prevent rotation of the lever by being pushed by the balance weight when a normal inertial force of the balance weight acting in the outside direction of the vehicle is generated.

2. The door outside handle assembly of claim 1, comprising a guide slot formed in the base to guide the movement of the balance weight, and the balance weight is movably coupled to the guide slot.

3. The door outside handle assembly of claim 2, wherein the balance weight comprises pins protruding from opposing end portions thereof, and the pins are inserted into the guide slots disposed in parallel in the base.

4. The door outside handle assembly of claim 1, further comprising a weight return spring that is disposed between the balance weight and the base to provide an elastic restoring force for returning the balance weight in a state deformed by the balance weight moving in the inside direction of the vehicle.

5. The door outside handle assembly of claim 4, wherein the weight return spring are two parallel coil springs having one end portion thereof coupled to the pin disposed at each end portion of the balance weight and the other end portion thereof coupled to the base.
